(19) United States
(12) Patent Application Publication
(10) Pub. No.: US 2026/0161878 A1
(43) Pub. Date: Jun. 11, 2026

(54) SYSTEMS AND METHODS OF ADJUSTING DISPLAY CHARACTERISTICS BASED ON DATA OF THE USER

(71) Applicant: Apple Inc., Cupertino, CA (US)

(72) Inventors: Ian PERRY, San Jose, CA (US); Brian W. TEMPLE, Santa Clara, CA (US); Parth ARORA, Atlanta, GA (US); Trent A. GREENE, Santa Clara, CA (US); Ioana NEGOITA, Sunnyvale, CA (US)

(21) Appl. No.: 19/366,062

(22) Filed: Oct. 22, 2025

Related U.S. Application Data
(60) Provisional application No. 63/729,221, filed on Dec. 6, 2024.

(51) Int. Cl. G06F 40/109; G06F 3/04815

(52) U.S. Cl. CPC G06F 40/109; G06F 3/04815

(57) ABSTRACT

In some examples, the electronic device or a second electronic device in communication with the electronic device displays text at a first font size. In some examples, while displaying text at the first font size, the electronic device obtains a first set of data relating to the user of the electronic device and stores the first set of data. In some examples, at a second time, after the first time, the electronic device obtains a second set of data related to the user of the electronic device. In some examples, the electronic device compares the first set of data and the second set of data and if the second set of data satisfies one or more criteria, the electronic device updates the text size from the first font size to a second font size.

### CROSS REFERENCE TO RELATED APPLICATIONS

This application claims the benefit of U.S. Provisional Application No. 63/729,221, filed Dec. 6, 2024, the content of which is herein incorporated by reference in its entirety for all purposes.

### FIELD OF THE DISCLOSURE

This relates generally to systems and methods for adjusting display characteristics based on data of the user, and more particularly to adjusting font size and other display characteristics based on a set of data of the user from the electronic device.

### BACKGROUND OF THE DISCLOSURE

Some computer graphical environments provide two-dimensional and/or three-dimensional environments where at least some objects displayed for a user's viewing are virtual and generated by a computer. In some examples, an electronic device passively obtains biometric data while the user is using the electronic device. In some examples, the biometric data is used to determine a font size for text.

### SUMMARY OF THE DISCLOSURE

This relates generally to systems and methods for adjusting display characteristics based on data of the user, and more particularly to adjusting font size and other display characteristics based on a set of data of the user from the electronic device. In some examples, the electronic device or a second electronic device in communication with the electronic device displays text at a first font size. In some examples, while displaying text at the first font size, the electronic device obtains a first set of data relating to the user of the electronic device and stores the first set of data. In some examples, at a second time, after the first time, the electronic device obtains a second set of data related to the user of the electronic device. In some examples, the electronic device compares the first set of data and the second set of data and if the second set of data satisfies one or more criteria, the electronic device updates the text size from the first font size to a second font size. In some examples, the electronic device presents extended reality to detect a font size of a display.

In some examples, presenting the extended reality environment at an electronic device includes presenting pass-through video of the physical environment of the electronic device. As described herein, for example, presenting pass-through video can include displaying virtual or video passthrough in which the electronic device uses a display to present images of the physical environment and/or presenting true or real passthrough in which portions of the physical environment are visible to the user through a transparent portion of the display.

The full descriptions of these examples are provided in the Drawings and the Detailed Description, and it is understood that this Summary does not limit the scope of the disclosure in any way.

### BRIEF DESCRIPTION OF THE DRAWINGS

FIG. 1 illustrates an electronic device presenting a three-dimensional environment according to some examples of the disclosure.

FIGS. 2A-2B illustrate block diagrams of example architectures for electronic devices according to some examples of the disclosure.

FIGS. 3A-3M illustrate the electronic device capturing data and changing display characteristics based on the data according to some examples of the disclosure.

FIG. 4 illustrates a block diagram including process 400 for updating a workplace set up based on a set of data according to some examples of the disclosure.

FIG. 5 illustrates a flow diagram illustrating an example process for adjusting display characteristics based on a set of data related to a user of the electronic device according to some examples of the disclosure.

### DETAILED DESCRIPTION

This relates generally to systems and methods for adjusting display characteristics based on biometric data, and more particularly to adjusting font size and other display characteristics based on a set of biometric data of the electronic device. In some examples, the electronic device or a second electronic device in communication with the electronic device displays text at a first font size. In some examples, while displaying text at the first font size, the electronic device obtains a first set of data relating to the user of the electronic device and stores the first set of data. In some examples, at a second time, after the first time, the electronic device obtains a second set of data related to the user of the electronic device. In some examples, the electronic device compares the first set of data and the second set of data and if the second set of data satisfies one or more criteria, the electronic device updates the text size from the first font size to a second font size. In some examples, the electronic device presents extended reality to detect a font size of a display.

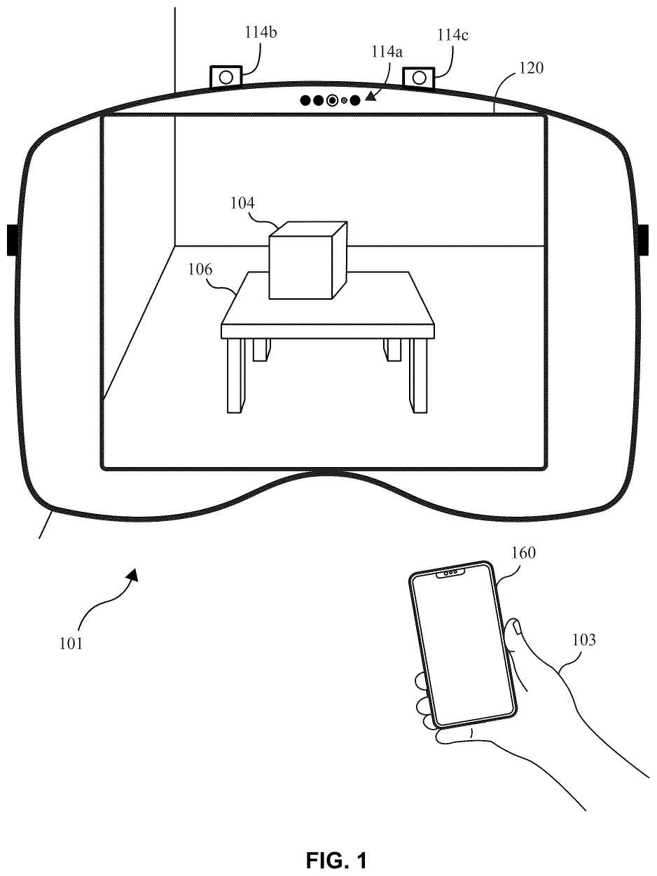

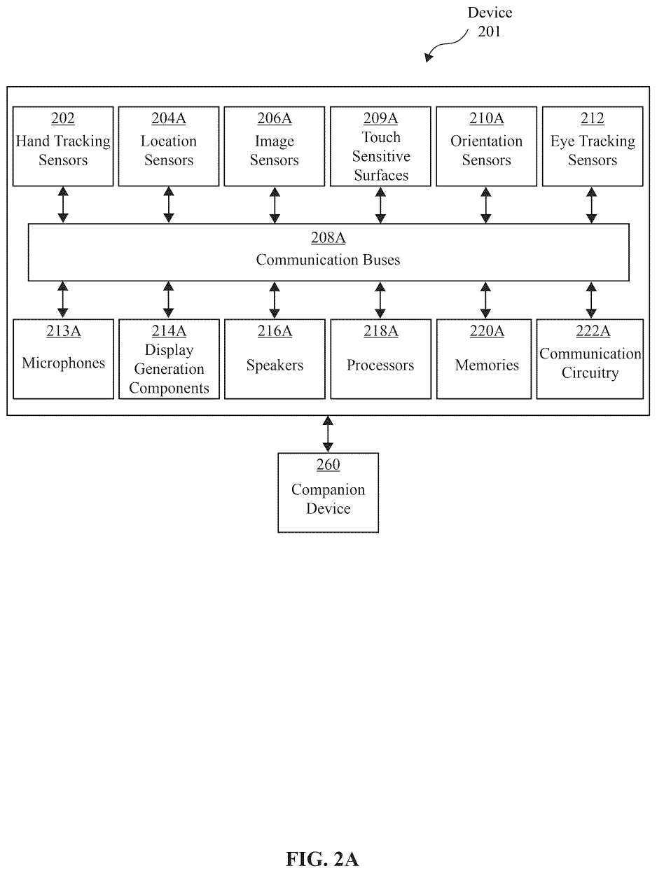

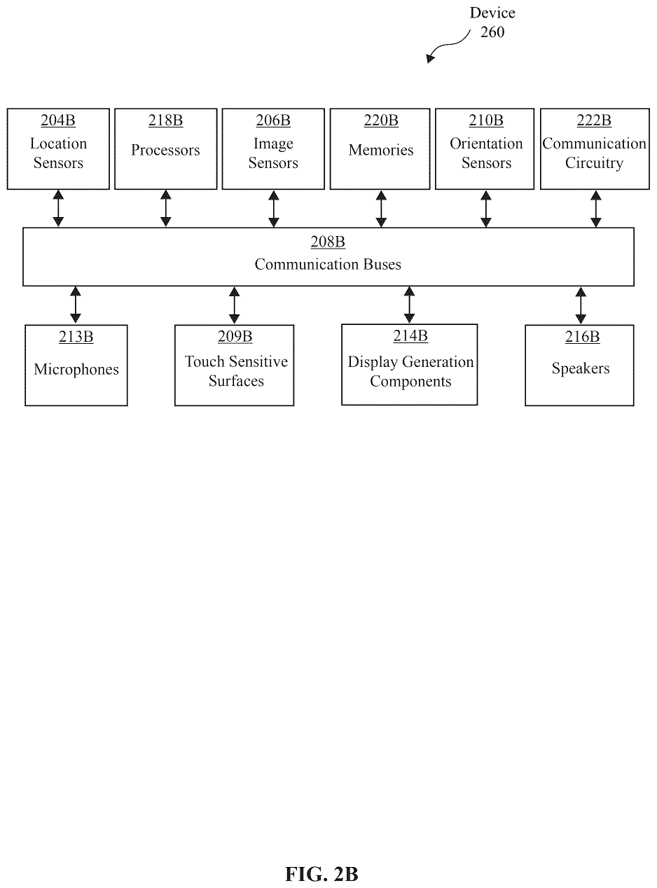

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards an electronic device (e.g., corresponding to electronic device 201 and/or electronic device 101) that can capture biometric data of a user passively while the user is wearing and/or using the electronic device. As discussed below, the electronic device may detect, using one or more input devices (e.g., orientation sensor(s) 210, image sensor(s) 206, ambient sensor(s) 224, and/or other sensors) biometric data including eye data (e.g., squinting data, pupil data, gaze data, and other eye data), ergonomics data (e.g., body lean), and distance data (e.g., distance from the one or more displays). In some examples, the electronic device may use the biometric data to establish a baseline (e.g., the first set of data). In some examples, if the second set of data deviates from the first set of data (e.g., by more than a threshold amount, and/or by satisfying one or more criteria), then the electronic device may change the font size of the text displayed on the one or more displays. The first and second set of data is unique to each user. Biometric measurements may change based on environmental factors (e.g., lighting, chair position, display position, keyboard position, and other factors). Some displays require that a user manually change the font size and/or display scale. These displays do not factor in data from the user in determining an appropriate font size and/or display scale.

To solve the technical problem outlined above, exemplary methods and/or systems are provided where the electronic device automatically records data relating to the user. The electronic device may opportunistically capture data relating to the user (e.g., if the electronic device is turned on (e.g., on a high power mode) as a result of the electronic device capturing data to inform one or more functions of the electronic device. In some examples, the electronic device enters a high power mode when the electronic device activates one or more displays (e.g., the electronic device receives a notification and activates one or more displays and/or the user turns on the one or more display via an input (e.g., pressing a button)) and/or if the electronic device transitions from a locked mode to an unlocked mode. In some examples, a locked mode includes a whole-device lock and/or an application-lock. For example, while in the locked mode, the electronic device does not display content on the device (e.g., application data, personal data stored on the electronic device, or other protected data), or the content of the respective applications (e.g., protected data of an application while data from other applications are accessible on the electronic device). In some examples, while in the locked mode, the electronic device displays less or different data. For example, the electronic device has restricted functionality during the locked mode (e.g., can receive calls but cannot transmit calls). In some examples, an unlocked mode is a mode in which the electronic device displays the contents (e.g., the previously protected data) of the electronic device and/or of the respective application, or when the previously restricted functionality is no longer restricted. In some examples, the high-power state includes turning on or entering a higher-power state for the output devices or sensors, such as turning on the one or more displays, processing at a higher power (e.g., at a higher frequency than while in the low power state), having a higher refresh rate, and/or operating background applications. In some examples, transitioning to a high power state includes turning on additional processors. For example, while in a low power state (e.g., the electronic device is locked), the electronic device uses a low power processor to monitor one or more sensors/input devices that operate at the lower power state and/or determine an environmental context of the electronic device.

If deviations based on the data are detected, the user may be notified of a potential deviation. Triggering actively monitoring data (e.g., by capturing second biometric data as described below) opportunistically reduces the number of passively running sensors, or the duration and/or number of measurements by the sensors, thereby saving power and/or other computing resources of the electronic device.

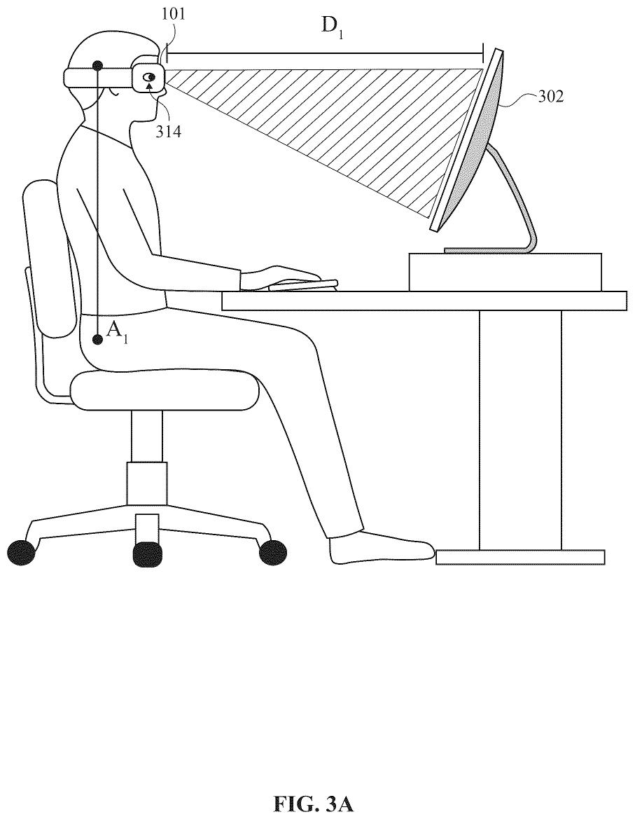

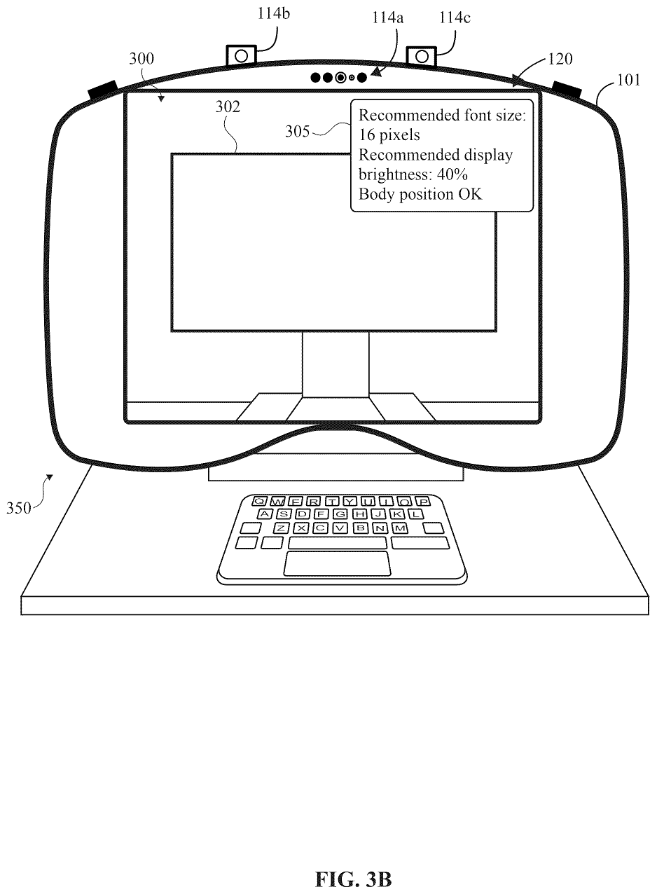

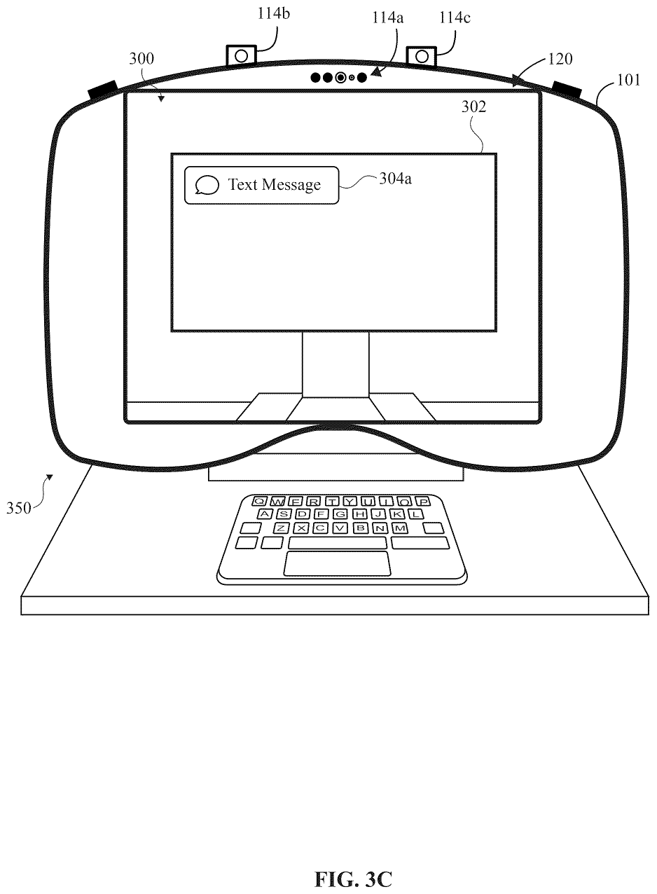

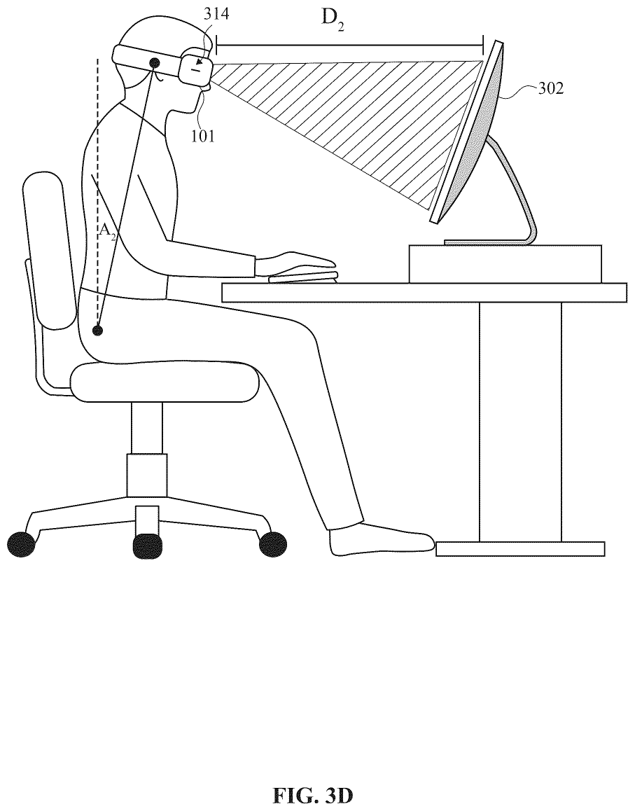

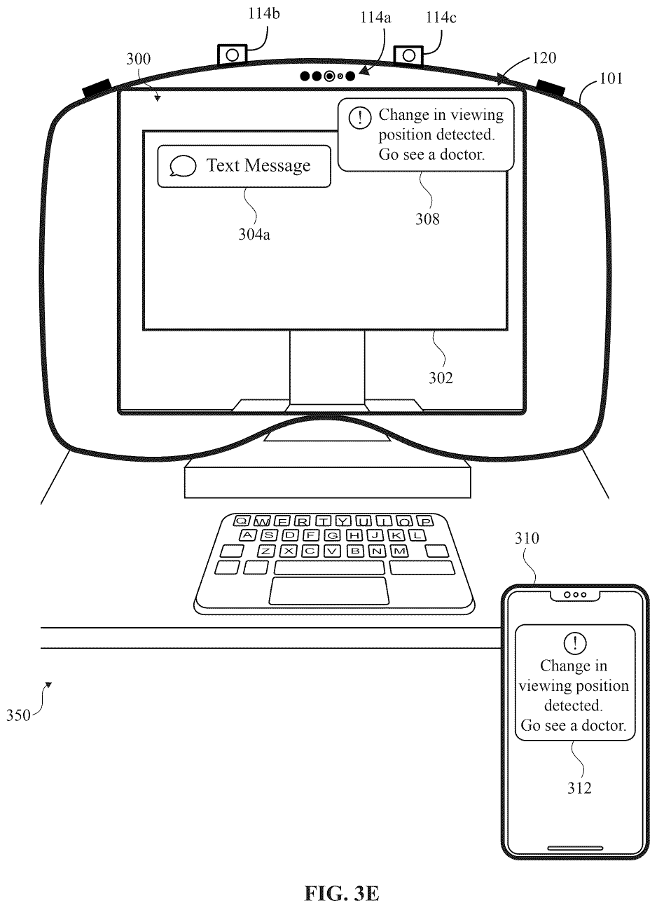

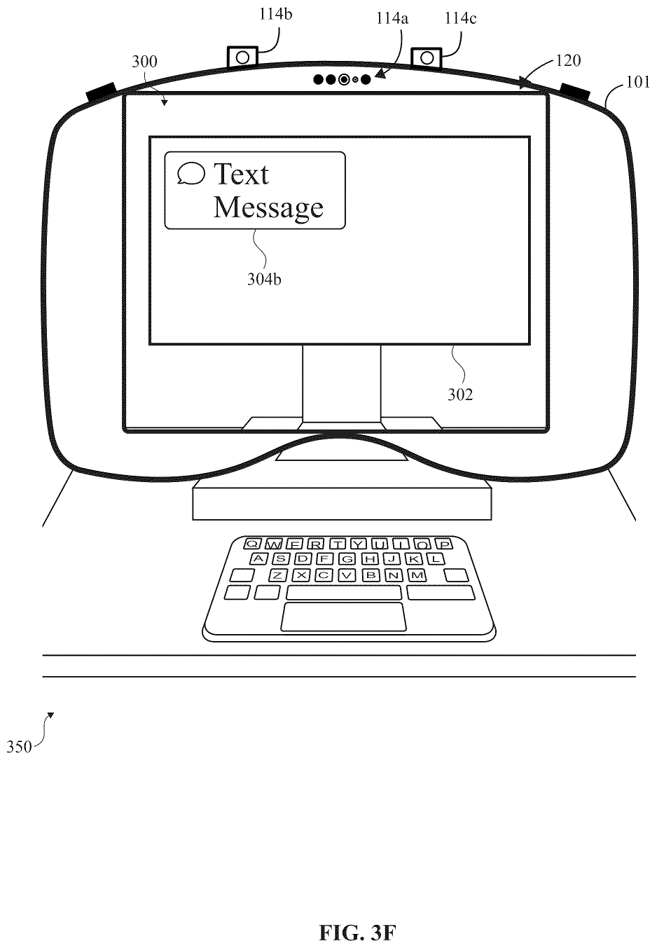

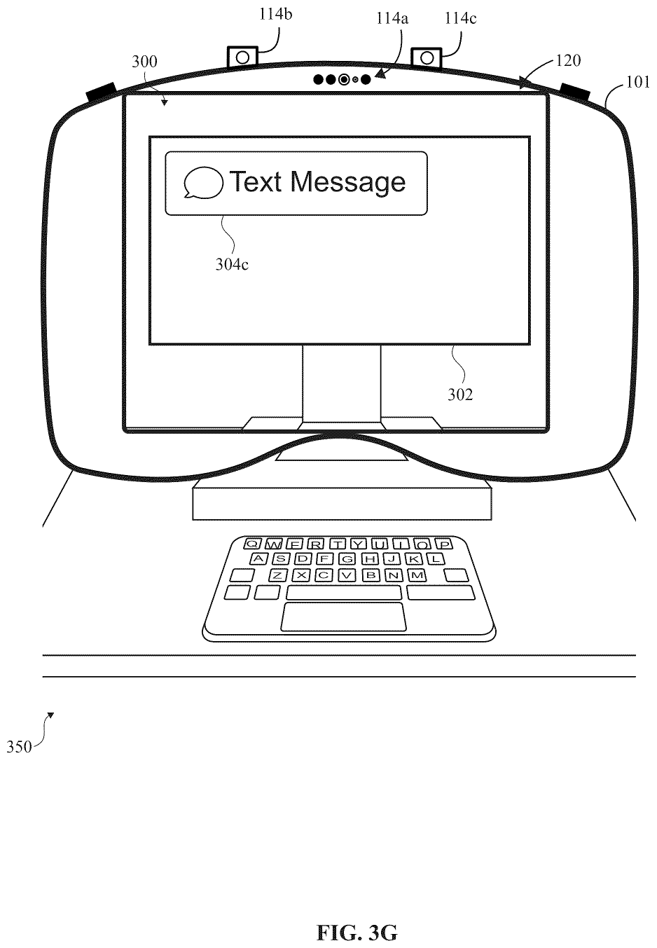

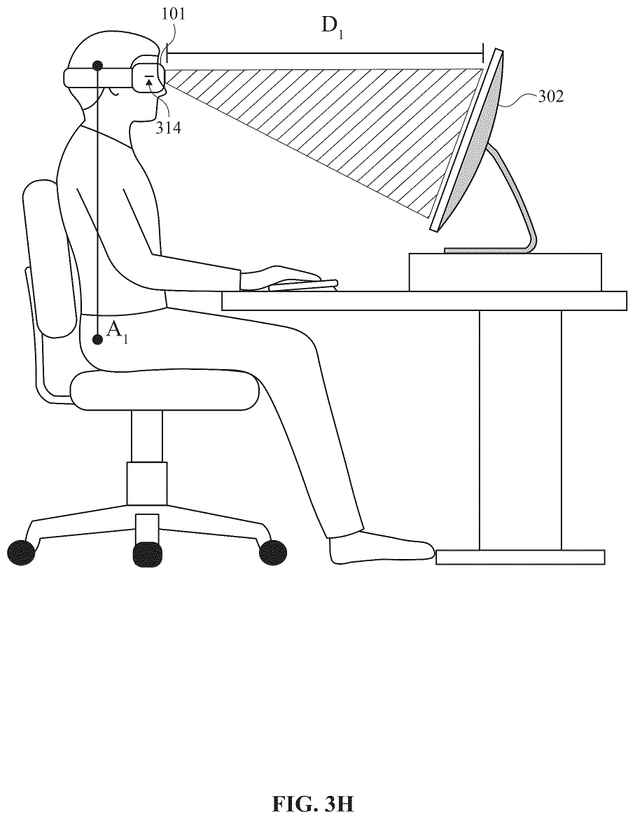

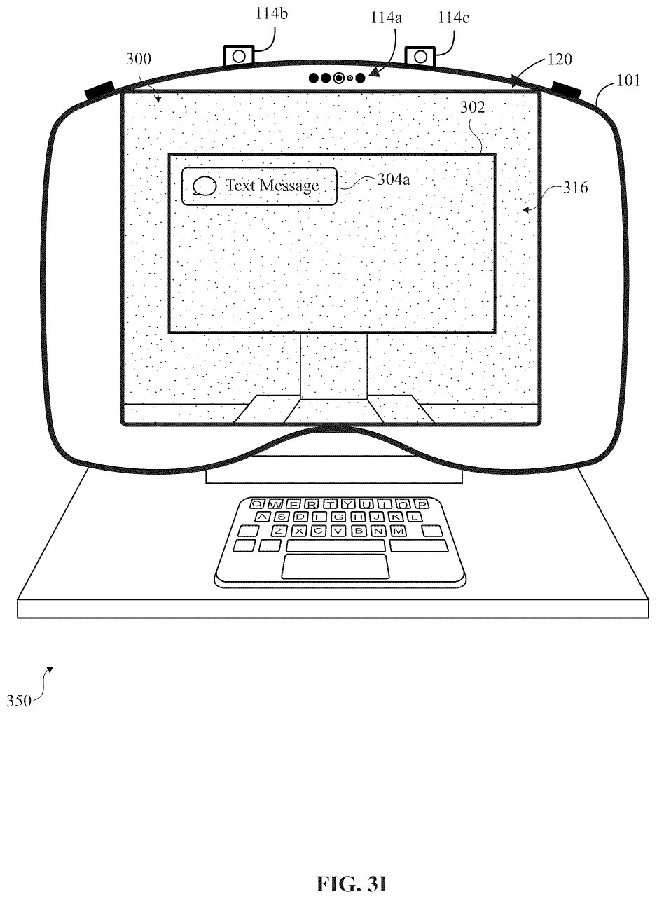

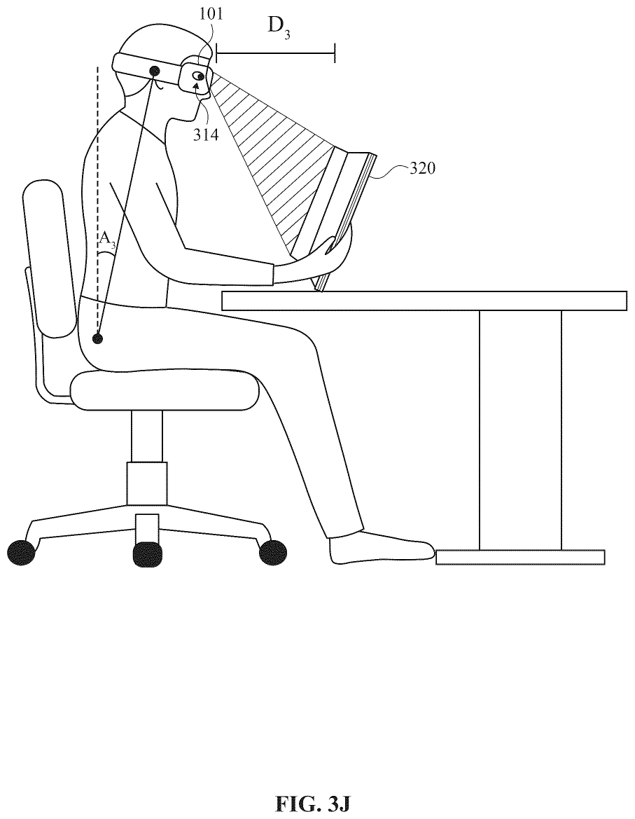

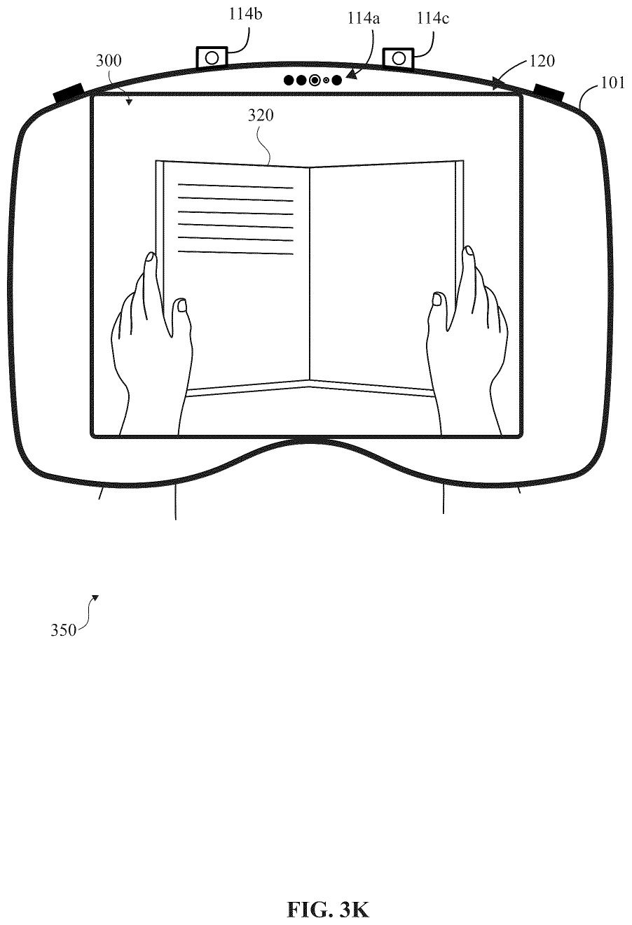

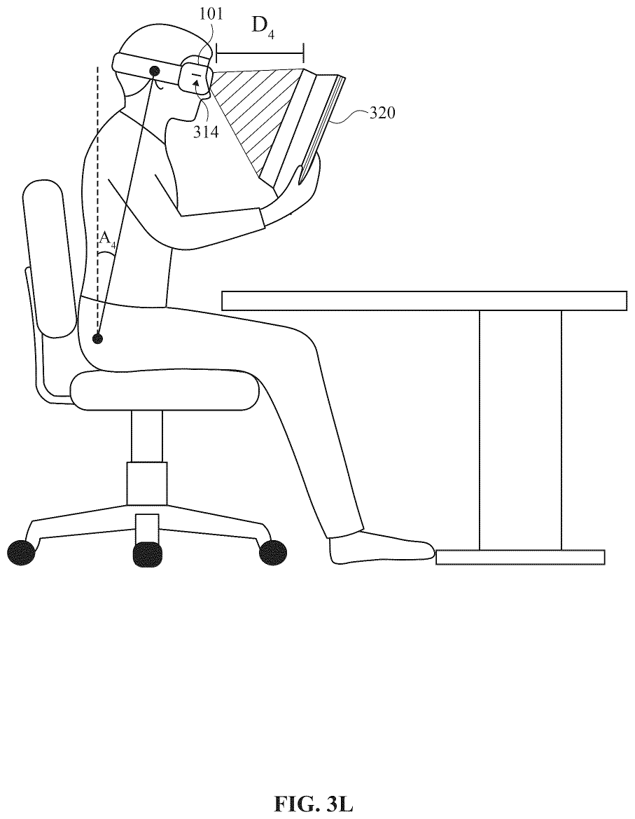

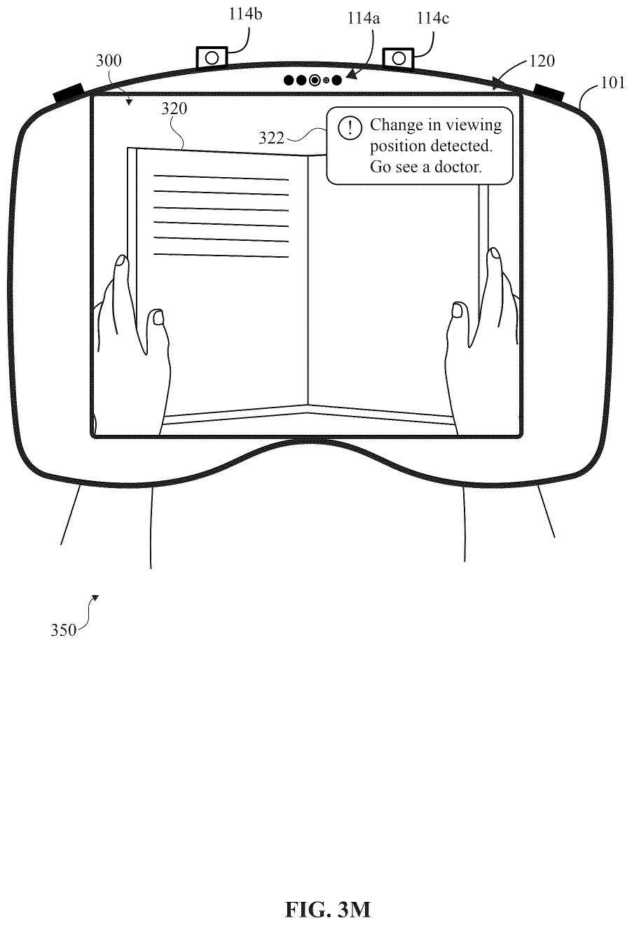

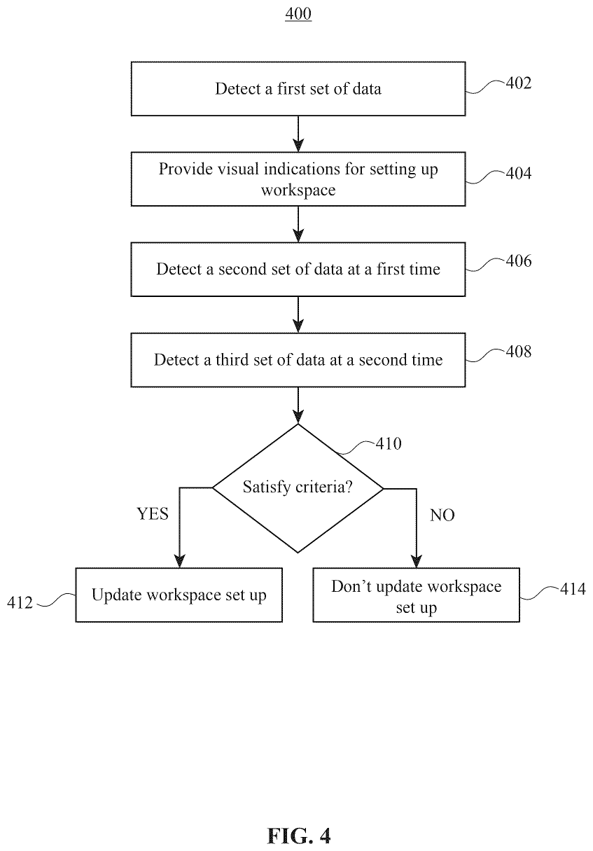

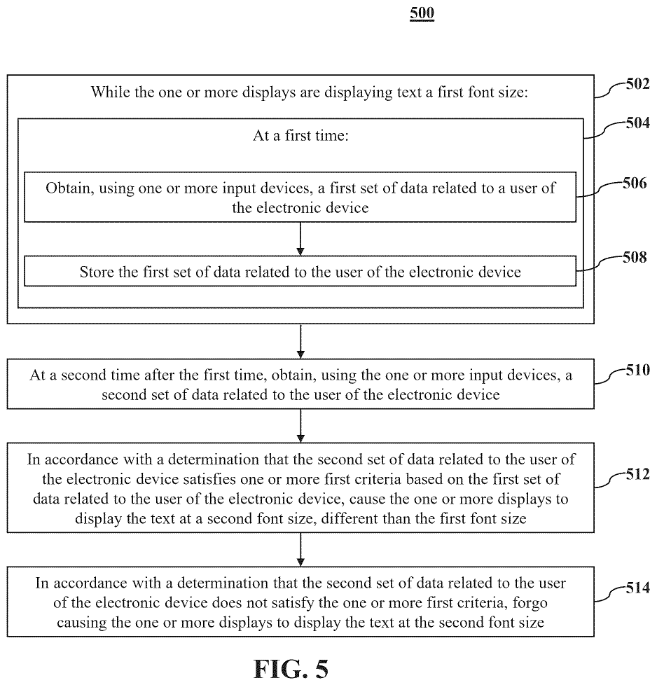

FIGS. 3A-3M illustrate examples of the electronic device capturing data and changing display characteristics based on the data. FIGS. 3A-3M are used to illustrate the processes described below, including process 400, shown in FIG. 4, and process 500, shown in FIG. 5. FIG. 3A illustrates an example of a first set of data captured by the electronic device 101 at a first time. In some examples, the electronic device 101 is optionally a head-mounted display similar or corresponding to device 201 of FIGS. 2A-2B. In some examples, the electronic device, such as electronic device 101, obtains a first set of data related to a user of the electronic device using one or more input devices (e.g., image sensors (e.g., inward and outward facing cameras), position sensors, orientation sensors, inertial measurement units, ambient sensors, and/or other sensors as described in FIGS. 2A-2B). For example, the first set of data includes eye data (e.g., pupil dilation, and/or squinting), body positioning (e.g., position of a user's wrists and hands), position of the electronic device relative to the ground, and/or distance from the electronic device to a second electronic device. In some examples, the electronic device 101 obtains the first set of data in response to determining that the user of the electronic device 101 is at a workplace (e.g., a physical workplace, such as a desk). For example, the electronic device 101 uses the one or more sensors to detect that the user is sitting at a desk and looking at a monitor, computer, and/or book.

In FIG. 3A, the electronic device 101 uses the one or more sensors to detect the first set of data such as a distance D1 between the electronic device 101 and an electronic device 302, in communication with the electronic device 101. Additionally, the electronic device 101 uses the one or more sensors to detect an angle A1, which is an angle of the position of the electronic device 101 relative to a normal vector of gravity (e.g., the angle corresponds to the lean of a user's torso). Additionally, electronic device 101 uses the one or more sensors to detect hand position, eye squinting, and/or head positioning. For example, in FIG. 3A, the electronic device 101 detects that the user's eyes 314 are not in a squinting position. For example, the electronic device 101 uses the inward facing cameras to determine that a portion of the user's pupils and/or irises are visible.

In some examples, electronic device 302 includes the one or more displays with which the electronic device 302 displays text. In some examples, electronic device 101 and electronic device 302 share a user account and/or are in communication via a wireless or wired connection (e.g., Bluetooth, WiFi, near-field communication, and/or other connections). In some examples, electronic device 101 may control the one or more displays of electronic device 302 (e.g., one or more inputs directed towards electronic device 101 may change one or more characteristics/settings of electronic device 302). In some examples, electronic device 302 is a laptop including a display. In some examples, the electronic device 101 may be in communication with additional electronic devices which may include displays (e.g., smart watches, tablets, smart phones, and/or other devices).

In some examples, in FIG. 3A, the electronic device 101 detects that the user is at the workplace for the first time. For example, the electronic device 101 has not previously detected electronic device 302 and/or electronic device 101 is at a location not previously known as a location with a workplace (e.g., not a place of work, home, and/or not a known location that the electronic device 101 has previously been). In response to detecting that the workplace is a new workplace, the electronic device 101 uses the first set of data to determine a recommended font size, brightness, body positioning (e.g., position of a user's wrists, distance between the user's head) and the electronic device 302 (e.g., distance D1), and/or other ergonomic criteria.

In some examples, the electronic device 101 determines a recommended font size using the distance between the electronic device 101 and the electronic device 302 (e.g., the display of electronic device 302). For example, the electronic device 101 uses distance D1, shown in FIG. 3A. In some examples, the electronic device 101 uses a set distance between the electronic device 101 and the electronic device 302. For example, the electronic device 101 instructs the user to move the electronic device 101 such that the distance D1 is the set distance (e.g., 0.25 meters, 0.5 meters, or 1 meter). In some examples, the set distance is an optimal viewing distance for viewing text on a display. After determining that the electronic device 101 is the respective distance away from electronic device 302, the electronic device 101 adjusts the font size by decreasing the font size (e.g., by 1 pixel, 5 pixels, 10 pixels, or 20 pixels) until the font size is no longer legible to the user of electronic device 101 (e.g., the largest font size where the text is not legible and/or the smallest font size where the text is legible). For example, the electronic device 101 detects a user input that indicates a font size where the text is no longer legible (e.g., the text is blurry and/or not readable). In some examples, the electronic device 101 determines the recommended font size by multiplying the font size where the text is no longer legible by a font multiplier (e.g., 2×, 3×, 5×, or 10×).

FIG. 3B illustrates an example of the electronic device 101 displaying recommendations to setup the workplace based on the first set of data. In FIG. 3B, the electronic device 101 is presenting, via the display 120, a portion 300 of a physical environment 350 from a viewpoint of the user of the electronic device 101. In FIG. 3B, the electronic device 101 optionally presents portion 300 via a video pass-through or optical see-through display. FIG. 3B shows a user viewing electronic device 302 through electronic device 101.

In some examples, a viewpoint of a user influences what content (e.g., physical and/or virtual objects) is visible in a viewport (e.g., a view of the physical environment 350 visible to the user via one or more displays 120, a display, or a pair of display modules that provide stereoscopic content to different eyes of the same user). In some examples, the (virtual) viewport has a viewport boundary that defines an extent of the physical environment 350 that is visible to the user via the display 120 in FIGS. 3B, 3D, 3E, 3F, 3H, 3I, and 3M. In some examples, the region defined by the viewport boundary is smaller than a range of vision of the user in one or more dimensions (e.g., based on the range of vision of the user, size, optical properties or other physical characteristics of the one or more displays, and/or the location and/or orientation of the one or more displays relative to the eyes of the user). In some examples, the region defined by the viewport boundary is larger than a range of vision of the user in one or more dimensions (e.g., based on the range of vision of the user, size, optical properties or other physical characteristics of the one or more displays, and/or the location and/or orientation of the one or more displays relative to the eyes of the user). The viewport and viewport boundary typically move as the one or more displays move (e.g., moving with a head of the user for a head mounted device or moving with a hand of a user for a handheld device such as a tablet or smartphone). A viewpoint of a user influences what content is visible in the viewport, a viewpoint generally specifies a location and a direction relative to the physical environment 350, and as the viewpoint shifts, the view of the physical environment 350 will also shift in the viewport. For a head mounted device, a viewpoint is typically based on a location and a direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include displays with video passthrough, portions of the physical environment that are visible (e.g., displayed, and/or projected) via the one or more displays are based on a field of view of one or more cameras in communication with the displays which typically move with the displays (e.g., moving with a head of the user for a head-mounted device or moving with a hand of a user for a handheld device such as a tablet or smartphone) because the viewpoint of the user moves as the field of view of the one or more cameras moves (and the appearance of one or more virtual objects displayed via the one or more displays is updated based on the viewpoint of the user (e.g., displayed positions and poses of the virtual objects are updated based on the movement of the viewpoint of the user)). For displays with optical see-through, portions of the physical environment that are visible (e.g., optically visible through one or more partially or fully transparent portions of the display generation component) via the one or more displays are based on a field of view of a user through the partially or fully transparent portions of the display generation component (e.g., moving with a head of the user for a head mounted device or moving with a hand of a user for a handheld device such as a tablet or smartphone) because the viewpoint of the user moves as the field of view of the user through the partially or fully transparent portions of the displays moves (and the appearance of one or more virtual objects is updated based on the viewpoint of the user).

In FIG. 3B, the electronic device 101 displays indication 305 including one or more recommendations based on the first set of data. In some examples, the electronic device 101 detects the first set of data and provides instructions for displaying the one or more recommendations. In FIG. 3B, indication 305 includes text describing a recommended font size, display brightness, and body position. In FIG. 3B, the indication 305 indicates that the body position (e.g., illustrated in FIG. 3A) is “okay”. In some examples, electronic device 101 compares data from the first set of data (e.g., wrist position, distance D1, and angle A1) to a set of optimal data (e.g., determined by electronic device 101 and/or previously stored on electronic device 101). In some examples, if the first set of data includes data not within a threshold range of the optimal data (e.g., within 1%, 5%, 10%, or 50%) of the threshold range, then the electronic device 101 would display text in indication 305 indicating a need for a change in body position. For example, FIG. 3D, described below, illustrates an example of poor body position (e.g., head position too close to electronic device 101, and a body lean indicated by angle A2).

FIG. 3C illustrates an example of the electronic device 302 displaying content including text at a first font size based on the recommendations illustrated in FIG. 3C. In FIG. 3C, the electronic device 101 and/or electronic device 302 detects an event, such as receiving an electronic message from another electronic device. In response to detecting the event, the electronic device 302 displays an indication 304a of a notification corresponding to the event, including displaying text (e.g., “Text Message”) at a first font size. In some examples, while displaying the text at the first font size, the electronic device detects that the user of electronic device 101 is looking at a display of electronic device 302. In response to detecting that the user is looking at electronic device 302, the electronic device 101 obtains a second set of data (e.g., which may include data similar or the same as the first set of data) at a second time. In some examples, the electronic device 101 obtains the second set of data opportunistically. For example, the electronic device 101 obtains the second set of data while the electronic device 101 is in a high power state, as described above. In some examples, the electronic device 101 may enter the high power state in response to receiving the notification corresponding to indication 304a. Alternatively, or additionally, in some examples, the electronic device 101 obtains the second set of data in response to detecting an environmental context including a workspace. For example, the electronic device 101 uses the one or more input devices (e.g., outward and/or inward facing cameras) to determine that the electronic device 101 is in a workspace (e.g., detecting electronic device 302, detecting that the user is sitting at a desk, detecting a keyboard, and/or detecting that the user is reading (e.g., a book and/or text on a display)).

FIG. 3D illustrates the electronic device 101 capturing a third set of data related to the user. In some examples, the electronic device 101 obtains the third set of data at a third time, after the second time. In some examples, the electronic device 101 obtains the third set of data, opportunistically (e.g., while the electronic device 101 is in a high-power state to inform one or more functions of the electronic device 101). In FIG. 3D, the posture of the user of electronic device 101 has changed and electronic device 101 detects a change in data from the second set of data to the third set of data that satisfies one or more criteria. For example, distance D2 is shorter than distance D1, and angle A2 is larger than angle A1. Additionally, the electronic device 101 detects that the user's eyes 314 are in a squinting position. For example, the electronic device 101 uses the inward facing cameras to determine that a portion of the user's pupils and/or irises are less visible that in FIG. 3A. In FIG. 3D, the third set of data includes data that exceeds a threshold based on the first set of data. For example, one or more of the measurements in the third set of data exceeds a threshold range (e.g., exceeding ±1%, ±5%, ±10%, ±50%, or ±75% of the measurements from the first set and/or second set of data) based on the first set and/or second set of data. In some examples, if the third set of data does not satisfy the one or more criteria, then the electronic device 101 does not change the font size or display the indication shown in FIG. 3E.

FIG. 3E illustrates an example of an indication displayed on electronic device 101 and/or an electronic device (e.g., electronic device 310 and/or electronic device 302) in communication with electronic device 101 in response to detecting that the third set of data exceeds the threshold range. In response to detecting that the third set of data satisfies the criteria (e.g., the threshold criteria), the electronic device 101 displays indication 308 including text indicating that a change in position was detected and to potentially see a doctor (e.g., to get a new glasses prescription)). In some examples, an electronic device in communication with electronic device 101 may display the indication. For example, in FIG. 3E, electronic device 310, a smart phone in communication with electronic device 101, displays indication 312, which corresponds to indication 308. In some examples, any electronic device in communication with electronic device 101 and/or any combination of devices in communication with electronic device 101 may performed one or more of the actions described herein (e.g., electronic device 302, electronic device 310, and/or electronic device 101).

In some examples, after displaying indication 308 and/or 312, the electronic device 101 updates the font size of the text displayed on electronic device 101 from the first font size to a second font size, as shown in FIG. 3F and FIG. 3G. In some examples, the second font size is larger than the first font size because the electronic device 101 detects that the user is at a closer distance (D2) and squinting to view text at the first font size. Therefore, to allow the user to maintain a proper ergonomic position (e.g., with angle A1 and distance D1, shown in FIG. 3A), the electronic device 101 increases the font size. In some examples, the electronic device 101 displays an indication including a selectable option that is selectable to update the font size, prior to updating the font size. In these examples, the electronic device updates the font size in response to detecting selection of the selectable option. In some examples, the electronic device 101 automatically updates the font size based on the captured set of data. In some examples, as the electronic device 101 obtains additional sets of data at different times, the electronic device 101 dynamically updates the font size. For example, after capturing the third set of data, the electronic device obtains a fourth set of data, at a fourth time. Based on the comparison of the fourth set of data to the second set of data (and/or the first set of data), the electronic device updates the font size from the second font size to a third font size (e.g., the third font size is larger or smaller than the second font size). In some examples, if the fourth set of data is the same as (or similar to (e.g., within a margin of error)) of the third set of data, then the electronic device 101 does not change the font size (e.g., the font size remains the third font size).

FIG. 3F illustrates an example of the electronic device 101 increasing the font size by changing the size of the font from 16 pixels to, for example, 25 pixels. For example, in FIG. 3F, the electronic device displays indication 304b, where the text is at a font size larger than indication 304a, shown in FIG. 3E. In some examples, the increase in font size corresponds to a mathematical correlation between distance D1, distance D2, and the first font size. In some examples, in FIG. 3E, the electronic device 101 adjusts the font size without adjusting the display scale. For example, the electronic device 101 increases the font size (or decreases the font size) without increasing or decreasing the size of other user interface elements such as images, graphical elements, and/or one or more dimensions of containers such as windows, platters, or other containers. FIG. 3G illustrates an example of the electronic device 101 increasing the font size by changing the display scale of electronic device 302. For example, the electronic device 101 increases the display scale of electronic device 302 by displaying user interface elements such as indication 304c at a larger size than shown in FIG. 3E (e.g., indication 304a).

FIG. 3H illustrates an example where the electronic device 101 obtains a third set of data including squinting. In FIG. 3H, the electronic device 101 obtains the third set of data including eye characteristics corresponding to squinting. In some examples, if the third set of data satisfies one or more second criteria based on the first and/or second set of data, then the electronic device adjusts the brightness level of electronic device 302 and/or electronic device 101. The one or more second criteria differ from the one or more criteria described in FIG. 3D because the one or more body position measurements remain within the margin of error (and/or remain the same) as the measurements gathered in the first and/or second sets of data, described above. For example, in FIG. 3H, the electronic device 101 determines that the angle A1 and distance D1 remain the same as the angle A1 and distance D1 shown in FIG. 3A. However, in FIG. 3H, the electronic device 101 obtains data indicating that the user is squinting and/or that the user's pupils are constricting. The third set of data satisfies the one or more second criteria because the one or more eye measurements and/or ambient light conditions changed but the one or more body measurements remained the same.

In response to determining the change in eye characteristics (e.g., squinting), the electronic device 101 changes the brightness of the display of electronic device 101, shown in FIG. 3I. In FIG. 3I, the brightness 316 of the display of electronic device 101 is a lower brightness than shown in FIG. 3E. In some examples, the electronic device 101 may lower the brightness of the display of electronic device 302 and/or other electronic devices in communication with electronic device 101. In some examples, based on the third set of data, the electronic device 101 may increase the brightness of the one or more displays. For example, if the third set of data includes pupil data and/or eye movement data and/or ambient light data that indicates eye strain because of a dim environment and/or a bight display, then the electronic device 101 may dim the one or more displays.

FIGS. 3J-3M illustrates an example of a workplace including a physical book. In FIG. 3J, the electronic device 101 identifies a workplace based on environmental context using the one or more input devices, as described above. For example, the electronic device 101 uses the image sensors to determine that the electronic device 101 is at a desk and the external cameras are facing a book that the user is holding. In some examples, the workplace in FIG. 3J is different than the workplace in FIG. 3A, as such, the data from the workplace in FIG. 3J is not compared to the data captured while in the workplace shown in FIG. 3A. In FIG. 3J, the electronic device 101 obtains a first set of data based on the user. In some examples, the first set of data includes an angle A3 and a distance D3. The angle A3 is an angle of the tilt of the electronic device 101 relative to a gravity vector. The distance D3 is a distance between the electronic device 101 and book 320.

FIG. 3K illustrates an example of the electronic device 101 is presenting, via the display 120, a portion 300 of a physical environment 350 from a point of view of the user of the electronic device 101 while the user reads book 320. In FIG. 3K, the electronic device 101 optionally presents the portion 300 of the physical environment 350 via a video pass-through or optical see-through display. FIG. 3K shows a user viewing book 320 through electronic device 101.

FIG. 3L illustrates the electronic device 101 capturing a second set of data while at a workplace including book 320. As described above, the electronic device 101 may capture additional data opportunistically. In FIG. 3L, the electronic device 101 obtains the second set of data and compares the second set of data against the first set of data. In some examples, if the second set of data satisfies one or more criteria, then the electronic device 101 displays an indication indicating a change in reading position. In some examples, the one or more criteria are described above with reference to FIG. 3D. For example, in FIG. 3L, the electronic device 101 detects that D4 is shorter than D3 by a threshold amount, and that A4 is different from A3 by a threshold amount. Additionally, in FIG. 3L, the electronic device 101 detects a change in eye position (e.g., squinting) although the ambient lighting conditions between the first set of data and the second set of data has not changed.

In response to detecting that the second set of data satisfies the one or more criteria, the electronic device 101 displays indication 322 on display 120. In some examples, while displaying a physical book (e.g., book 320) and/or other physical objects in the physical environment (e.g., that are optionally visible without being displayed with a display), the electronic device 101 does not change the font size. In some examples, the electronic device 101 displays an indication 322 including text recommending that the user visits a doctor and/or updates their vision prescription based on the change in viewing position. Alternatively, in some examples, the electronic device 101 changes the font size of book 320 through display 120 (e.g., by overlaying a larger font size using display 120 over the representation of book 320).

FIG. 4 illustrates a block diagram including process 400 for updating a workplace set up based on a set of data. At step 402, the electronic device (e.g., electronic device 101, shown in FIG. 3A) detects a first set of data. In some examples, the first set of data is captured while the electronic device 101 detects the workplace for the first time. For example, the workplace is a physical workplace, such as one including a desk, a computer, a monitor, a book, a chair, and/or other objects found in a physical workplace.

At step 404, the electronic device presents visual indications for setting up the workplace. For example, and as described in FIG. 3B, the electronic device provides a suggested brightness and font size for viewing text on a display. In some examples, the electronic device also provides one or more ergonomic suggestions for a sitting position. For example, the electronic device provides an optimal distance between the electronic device 101 and the display (e.g., electronic device 302, shown in FIG. 3A), an optimal angle between the electronic device and a normal vector for gravity, an optimal wrist position, and other ergonomic characteristics.

At step 406, the electronic device 101 obtains a second set of data, at a first time. In some examples, the electronic device obtains the second set of data after the user is finished setting up the workspace. In some examples, the electronic device 101 performs the workplace set up (e.g., detecting the first set of data and presenting the visual indications for setting up the workplace) once per workplace per device. For example, if the user wears a second head mounted device not in communication with electronic device 101, then the second head mounted device performs the workplace set up again. In some examples, the second set of data is the baseline data that additional sets of data are compared against. In some examples, the electronic device determines one or more threshold ranges that is used to determine if additional data satisfies the one or more criteria, as described in FIG. 3D. In some examples, the second set of data includes ergonomic data, eye data, and/or environmental data. For example, the second set of data (and the first set of data and/or the third set of data) includes eye position data (e.g., to determine eye squinting), pupil dilation/constriction data, ambient light data, distance data between the electronic device 101 and the electronic device 302 (e.g., distance D1, shown in FIG. 3A), angle data (e.g., angle A1, shown in FIG. 3A), wrist location data, and/or other data as described herein.

At step 408, the electronic device 101 obtains a third set of data, at a second time, after the first time. In some examples, the electronic device 101 obtains the third set of data opportunistically. For example, and as described in greater detail above, the electronic device 101 obtains the third set of data while in a high power mode (e.g., while the displays of electronic device 101 are active and/or while the electronic device 101 is unlocked). In some examples, the electronic device 101 compares the third set of data against the second set of data to determine if there are any deviations in the measurements. In some examples, if the one or more deviations satisfies the one or more criteria (step 410), then the electronic device 101 displays an indication indicating a change in data and adjusts the workspace set up (step 412) based on the change in data. For example, the electronic device 101 adjusts the brightness and/or text font size on electronic device 302. In some examples, if the third set of data does not satisfy the one or more criteria, then the electronic device 101 does not update the workplace set up (step 414).

FIG. 5 illustrates a flow diagram illustrating an example process for adjusting display characteristics based on a set of data related to a user of the electronic device according to some examples of the disclosure. In some examples, process 500 begins at an electronic device in communication with one or more displays and one or more input devices. In some examples, the electronic device is optionally a head-mounted display similar or corresponding to device 201 of FIGS. 2A-2B. As shown in FIG. 5, in some examples, at 502, while the one or more displays are displaying text a first font size, at a first time (504), the electronic device obtains (506), using one or more input devices, a first set of data related to a user of the electronic device. For example, the electronic device (e.g., electronic device 101 in FIG. 3A) presents a three-dimensional environment including portion 300, that includes a representation of electronic device 302 (e.g., which includes a display) that is displaying text at a first font size, as shown in FIG. 3C. As described in FIGS. 3A, 3C, and in FIG. 4, the first set of data includes ergonomic data and eye data (e.g., pupil dilation/constricting data and eye squinting data).

In some examples, at 508, the electronic device stores the first set of data related to the user of the electronic device. In some examples, the electronic device 101 stores the first set of data on electronic device 101 and/or on a device in communication with electronic device 101 (e.g., cloud storage and/or a second electronic device such as a laptop, smart phone, and/or table). In some examples, the electronic device 101 stores the first set of data to be used as baseline data when comparing additional data to the first set of data.

In some examples, at 510, at a second time after the first time, the electronic device obtains, using the one or more input devices, a second set of data related to the user of the electronic device, such as shown in FIG. 3D. In some examples, the second set of data is captured opportunistically, as described above. In some examples, the electronic device compares the second set of data to the first set of data stored by the electronic device. In some examples, the electronic device also stores the second set of data.

In some examples, at 512, in accordance with a determination that the second set of data related to the user of the electronic device satisfies one or more first criteria based on the first set of data related to the user of the electronic device, the electronic device cause the one or more displays to display the text at a second font size, different than the first font size, such as shown in FIGS. 3E and 3F. In some examples, the second set of data captured and shown in FIG. 3D, satisfies the one or more criteria relating to the first electronic device. For example, the second set of data deviates more than a threshold amount from the first set of data, as described in FIG. 3D and FIG. 4.

In some examples, at 514, in accordance with a determination that the second set of data related to the user of the electronic device does not satisfy the one or more first criteria, the electronic device forgoes causing the one or more displays to display the text at the second font size. For example, if the second set of data relating to the user does not satisfy the one or more first criteria, then the electronic device (e.g., electronic device 302) continues to display text at the first font size, shown in FIG. 3C.

It is understood that process 500 is an example and that more, fewer, or different operations can be performed in the same or in a different order. Additionally, the operations in process 500 described above are, optionally, implemented by running one or more functional modules in an information processing apparatus such as general-purpose processors (e.g., as described with respect to FIGS. 2A-2B) or application specific chips, and/or by other components of FIGS. 2A-2B.

Therefore, according to the above, some examples of the disclosure are directed to a method, comprising, an electronic device in communication with one or more input devices and one or more displays: while the one or more displays are displaying text a first font size: at a first time: obtaining, using the one or more input devices, a first set of data related to a user of the electronic device; and storing the first set of data related to the user of the electronic device; at a second time after the first time, obtaining, using the one or more input devices, a second set of data related to the user of the electronic device; in accordance with a determination that the second set of data related to the user of the electronic device satisfies one or more first criteria based on the first set of data related to the user of the electronic device, causing the one or more displays to display the text at a second font size, different than the first font size; and in accordance with a determination that the second set of data related to the user of the electronic device does not satisfy the one or more first criteria, forgoing causing the one or more displays to display the text at the second font size. Additionally or alternatively, in some examples, obtaining the first set of data and obtaining the second set of data includes obtaining respective data using an inertia measurement unit, internal facing camera, or an outward facing camera. Additionally or alternatively, in some examples, obtaining the first set of data and obtaining the second set of data includes obtaining eye data, ergonomics data, distance data, or gaze data. Additionally or alternatively, in some examples, while the one or more displays are displaying the text at the first font size and prior to the first time, detecting, via the one or more input devices, a workplace environmental context; in response to detecting the workplace environmental context: obtaining the first set of data related to the user. Additionally or alternatively, in some examples, prior to causing the one or more displays to display the text at the second font size and in accordance with the determination that the second set of data related to the user of the electronic device satisfies the one or more first criteria, causing the one or more displays to display a visual indication corresponding to the second set of data satisfying the one or more first criteria; and in response to receiving an input directed towards a selectable option to change a font size of the electronic device, causing the one or more displays to display the text at the second font size. Additionally or alternatively, in some examples, the one or more first criteria include a criterion that is satisfied when the second set of data includes data that exceeds a threshold based on the first set of data. Additionally or alternatively, in some examples, obtaining the second set of data at the second time also includes obtaining data to inform one or more functions of the electronic device. Additionally or alternatively, in some examples, obtaining the second set of data includes detecting squinting of one or more eyes of the user; and in response to detecting the squinting of the one or more eyes of the user that satisfies one or more second criteria, causing the one or more displays to update a brightness from a first brightness to a second brightness that is different from the first brightness. Additionally or alternatively, in some examples, causing the one or more displays to display the text at the second font size includes causing the one or more displays to update a display scale from a first scale to a second scale, wherein the second scale is at a larger zoom level than the first scale. Additionally or alternatively, in some examples, causing the one or more displays to display the text at the second font size includes causing the one or more displays to display the text at a larger font size than the first font size without changing a size of one or more other user interface elements displayed on the one or more displays. Additionally or alternatively, in some examples, prior to the one or more displays displaying the text at the first font size, detecting, via the one or more input devices, a third set of data; and in accordance with a determination that the third set of data satisfies one or more second criteria including a criterion that is satisfied when the third set of data corresponds to a second environment, causing the one or more displays to display a first indication of a recommended brightness, a second indication of a recommended font size, and one or more selectable options to modify the recommended brightness and the recommended font size. Additionally or alternatively, in some examples, the method includes determining the recommended font size including: detecting, via the one or more input devices, a first distance from the electronic device to the one or more displays; while the electronic device is at the first distance from the one or more displays, displaying the text at a third font size; while the electronic device is at the first distance from the one or more displays and while displaying the text at the third font size, adjusting the text to a fourth font size that is smaller than the third font size; and in accordance with a determination that the fourth font size satisfies a third set of criteria, multiplying a display factor to the fourth font size to determine a fifth font size corresponding to the recommended font size. Additionally or alternatively, in some examples, causing the one or more displays to display the text at a second font size includes automatically causing the one or more displays to update the first font size to the second font size based on the second set of data, and the method further comprises: while the one or more displays are displaying the text at the second font size, at a third time different from the first time and the second time, obtaining, using the one or more input devices, a third set of data related to the user of the electronic device; and in accordance with a determination that the third set of data related to the user of the electronic device satisfies the one or more first criteria based on the second set of data related to the user of the electronic device, automatically causing the one or more displays to display the text at a third font size, different than the second font size.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information. Specifically, as described herein, one aspect of the present disclosure is tracking a user's biometric data.

The present disclosure recognizes that the use of such personal information data, in the present technology, can be used to the benefit of users. For example, personal information data may be used to display text and/or change display settings based on changes in a user's biometric data. For example, the font size and/or display brightness is updated based on the user's data.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device in communication with one or more input devices and one or more displays:
while the one or more displays are displaying text a first font size:
at a first time:
obtaining, using the one or more input devices, a first set of data related to a user of the electronic device; and
storing the first set of data related to the user of the electronic device;
at a second time after the first time:
obtaining, using the one or more input devices, a second set of data related to the user of the electronic device;
in accordance with a determination that the second set of data related to the user of the electronic device satisfies one or more first criteria based on the first set of data related to the user of the electronic device, causing the one or more displays to display the text at a second font size, different than the first font size; and
in accordance with a determination that the second set of data related to the user of the electronic device does not satisfy the one or more first criteria, forgoing causing the one or more displays to display the text at the second font size.

2. The method of claim 1, wherein obtaining the first set of data and obtaining the second set of data includes obtaining respective data using an inertia measurement unit, internal facing camera, or an outward facing camera to obtain eye data, ergonomics data, distance data, or gaze data.

3. The method of claim 1, wherein while the one or more displays are displaying the text at the first font size, and the method further comprising:
prior to the first time, detecting, via the one or more input devices, a workplace environmental context;
in response to detecting the workplace environmental context:
obtaining the first set of data related to the user.

4. The method of claim 1, wherein prior to causing the one or more displays to display the text at the second font size and in accordance with the determination that the second set of data related to the user of the electronic device satisfies the one or more first criteria, causing the one or more displays to display a visual indication corresponding to the second set of data satisfying the one or more first criteria, and the method further comprising:
in response to receiving an input directed towards a selectable option to change a font size of the electronic device, causing the one or more displays to display the text at the second font size.

5. The method of claim 1, wherein the one or more first criteria include a criterion that is satisfied when the second set of data includes data that exceeds a threshold based on the first set of data.

6. The method of claim 1, wherein obtaining the second set of data at the second time also includes obtaining data to inform one or more functions of the electronic device.

7. The method of claim 1, wherein obtaining the second set of data includes detecting squinting of one or more eyes of the user, and the method further comprising:
in response to detecting the squinting of the one or more eyes of the user that satisfies one or more second criteria, causing the one or more displays to update a brightness from a first brightness to a second brightness that is different from the first brightness.

8. The method of claim 1, wherein:
causing the one or more displays to display the text at the second font size includes causing the one or more displays to update a display scale from a first scale to a second scale, wherein the second scale is at a larger zoom level than the first scale; or
causing the one or more displays to display the text at a larger font size than the first font size without changing a size of one or more other user interface elements displayed on the one or more displays.

9. An electronic device, comprising:
one or more processors;
one or more displays;
one or more input devices;
memory; and
one or more programs, wherein the one or more programs are stored in the memory and configured to be executed by the one or more processors, the one or more programs including instructions for:
while the one or more displays are displaying text a first font size:
at a first time:
obtaining, using the one or more input devices, a first set of data related to a user of the electronic device; and
storing the first set of data related to the user of the electronic device;
at a second time after the first time:
obtaining, using the one or more input devices, a second set of data related to the user of the electronic device;
in accordance with a determination that the second set of data related to the user of the electronic device satisfies one or more first criteria based on the first set of data related to the user of the electronic device, causing the one or more displays to display the text at a second font size, different than the first font size; and
in accordance with a determination that the second set of data related to the user of the electronic device does not satisfy the one or more first criteria, forgoing causing the one or more displays to display the text at the second font size.

10. The electronic device of claim 9, wherein obtaining the first set of data and obtaining the second set of data includes obtaining respective data using an inertia measurement unit, internal facing camera, or an outward facing camera to obtain eye data, ergonomics data, distance data, or gaze data.

11. The electronic device of claim 9, wherein while the one or more displays are displaying the text at the first font size, and the one or more programs further including instructions for:
prior to the first time, detecting, via the one or more input devices, a workplace environmental context;
in response to detecting the workplace environmental context:
obtaining the first set of data related to the user.

12. The electronic device of claim 9, wherein prior to causing the one or more displays to display the text at the second font size and in accordance with the determination that the second set of data related to the user of the electronic device satisfies the one or more first criteria, causing the one or more displays to display a visual indication corresponding to the second set of data satisfying the one or more first criteria, and the one or more programs further including instructions for:
in response to receiving an input directed towards a selectable option to change a font size of the electronic device, causing the one or more displays to display the text at the second font size.

13. The electronic device of claim 9, wherein the one or more first criteria include a criterion that is satisfied when the second set of data includes data that exceeds a threshold based on the first set of data.

14. The electronic device of claim 9, wherein obtaining the second set of data at the second time also includes obtaining data to inform one or more functions of the electronic device.

15. The electronic device of claim 9, wherein obtaining the second set of data includes detecting squinting of one or more eyes of the user, and the one or more programs further including instructions for:
in response to detecting the squinting of the one or more eyes of the user that satisfies one or more second criteria, causing the one or more displays to update a brightness from a first brightness to a second brightness that is different from the first brightness.

16. The electronic device of claim 9, wherein:
causing the one or more displays to display the text at the second font size includes causing the one or more displays to update a display scale from a first scale to a second scale, wherein the second scale is at a larger zoom level than the first scale;
or causing the one or more displays to display the text at a larger font size than the first font size without changing a size of one or more other user interface elements displayed on the one or more displays.

17. A non-transitory computer readable storage medium storing one or more programs, the one or more programs comprising instructions, which when executed by one or more processors of an electronic device, cause the electronic device to:
while one or more displays are displaying text a first font size:
at a first time:
obtain, using one or more input devices, a first set of data related to a user of the electronic device; and
store the first set of data related to the user of the electronic device;
at a second time after the first time:
obtain, using the one or more input devices, a second set of data related to the user of the electronic device;
in accordance with a determination that the second set of data related to the user of the electronic device satisfies one or more first criteria based on the first set of data related to the user of the electronic device, cause the one or more displays to display the text at a second font size, different than the first font size; and
in accordance with a determination that the second set of data related to the user of the electronic device does not satisfy the one or more first criteria, forgo causing the one or more displays to display the text at the second font size.

18. The non-transitory computer readable storage medium of claim 17, wherein obtaining the first set of data and obtaining the second set of data includes obtaining respective data using an inertia measurement unit, internal facing camera, or an outward facing camera to obtain eye data, ergonomics data, distance data, or gaze data.

19. The non-transitory computer readable storage medium of claim 17, wherein while the one or more displays are displaying the text at the first font size, and the instructions when executed by the one or more processors further cause the electronic device to:
prior to the first time, detect, via the one or more input devices, a workplace environmental context;
in response to detecting the workplace environmental context:
obtain the first set of data related to the user.

20. The non-transitory computer readable storage medium of claim 17, wherein prior to causing the one or more displays to display the text at the second font size and in accordance with the determination that the second set of data related to the user of the electronic device satisfies the one or more first criteria, causing the one or more displays to display a visual indication corresponding to the second set of data satisfying the one or more first criteria, and the instructions when executed by the one or more processors further cause the electronic device to:
in response to receiving an input directed towards a selectable option to change a font size of the electronic device, cause the one or more displays to display the text at the second font size.

21. The non-transitory computer readable storage medium of claim 17, wherein the one or more first criteria include a criterion that is satisfied when the second set of data includes data that exceeds a threshold based on the first set of data.

22. The non-transitory computer readable storage medium of claim 17, wherein obtaining the second set of data at the second time also includes obtaining data to inform one or more functions of the electronic device.

23. The non-transitory computer readable storage medium of claim 17, wherein obtaining the second set of data includes detecting squinting of one or more eyes of the user, and the instructions when executed by the one or more processors further cause the electronic device to:
in response to detecting the squinting of the one or more eyes of the user that satisfies one or more second criteria, cause the one or more displays to update a brightness from a first brightness to a second brightness that is different from the first brightness.

24. The non-transitory computer readable storage medium of claim 17, wherein:
causing the one or more displays to display the text at the second font size includes causing the one or more displays to update a display scale from a first scale to a second scale, wherein the second scale is at a larger zoom level than the first scale;
or causing the one or more displays to display the text at a larger font size than the first font size without changing a size of one or more other user interface elements displayed on the one or more displays.
